(19) United States
(12) Patent Application Publication
(10) Pub. No.: US 2021/0333962 A1
(43) Pub. Date: Oct. 28, 2021

(54) METHOD, SYSTEM AND APPARATUS FOR TOUCH GESTURE RECOGNITION

(71) Applicant: SAGE SENSES INC., Toronto (CA)

(72) Inventors: Arash ABGHARI, Kitchener (CA); Sergiu GIURGIU, Kitchener (CA)

(21) Appl. No.: 17/269,489

(22) PCT Filed: Jun. 7, 2019
(86) PCT No.: PCT/IB2019/054772

§ 371 Date: Feb. 18, 2021

Related U.S. Application Data
(60) Provisional application No. 62/720,508, filed on Aug. 21, 2018.

(51) Int. Cl. G06F 3/0488; G06K 9/62; G06N 20/00

(52) U.S. Cl. CPC G06F 3/0488; G06N 20/00; G06K 9/628

(57) ABSTRACT

A method, system and apparatus for touch gesture recognition are provided. A device generates a trajectory corresponding to a two-dimensional touch gesture. The device generates a plurality of variations of the trajectory in one or more of two dimensions. The device extracts one or more features of the trajectory and the plurality of variations of the trajectory. The device generates, from the one or more features, one or more machine learning classifiers. The device stores, at a memory, the one or more machine learning classifiers, such that a machine learning algorithm uses the one or more machine learning classifiers to recognize the two-dimensional touch gesture when receiving touch gesture input.

### CROSS-REFERENCE TO RELATED APPLICATIONS

This application claims priority from U.S. provisional patent application No. 62/720,508, filed Aug. 21, 2018 the contents of which is incorporated herein by reference.

### FIELD

The specification relates generally to motion sensing technologies, and specifically to a method, system and apparatus for touch gesture recognition.

### BACKGROUND OF THE INVENTION

Detecting predefined touch gestures from touch gesture data (e.g. touch sensor data) can be computationally complex, and may therefore not be well-supported by certain platforms, such as low-cost embedded circuits. As a result, deploying touch gesture recognition capabilities in such embedded systems may be difficult to achieve, and may result in poor functionality. Further, the definition of touch gestures for recognition and the deployment of such touch gestures to various devices, including the above-mentioned embedded systems, may require separately re-creating touch gestures for each deployment platform.

### BRIEF DESCRIPTION OF THE SEVERAL VIEWS OF THE DRAWINGS

For a better understanding of the various examples described herein and to show more clearly how they may be carried into effect, reference will now be made, by way of example only, to the accompanying drawings in which:

FIG. 1 depicts a system for touch gesture recognition, according to non-limiting examples.

FIG. 2 depicts certain internal components of the client device and server of the system of FIG. 1, according to non-limiting examples.

FIG. 3 depicts a method of touch gesture definition and recognition in the system of FIG. 1, according to non-limiting examples.

FIG. 4A and FIG. 4B depict generating a trajectory from touch gesture input, according to non-limiting examples.

FIG. 5 depicts generating a trajectory from script data, according to non-limiting examples.

FIG. 6 depicts generating variations of a trajectory using scaling, according to non-limiting examples.

FIG. 7 depicts generating variations of a trajectory using rotation, according to non-limiting examples.

FIG. 8 depicts generating variations of a trajectory using extensions, according to non-limiting examples.

FIG. 9 depicts generating variations of a trajectory using cropping and/or cutting, according to non-limiting examples.

FIG. 10 depicts generating variations of a trajectory using deforming, according to non-limiting examples.

FIG. 11 depicts extracting coordinate features of a trajectory, according to non-limiting examples.

FIG. 12 depicts extracting angular features of a trajectory, according to non-limiting examples.

FIG. 13 depicts generating one or more machine learning classifiers from one or more features, according to non-limiting examples.

FIG. 14 depicts storing one or more machine learning classifiers at a memory, according to non-limiting examples.

FIG. 15 depicts a device implementing one or more machine learning using one or more machine learning classifiers to recognize a two-dimensional touch gesture when receiving touch gesture input.

### DETAILED DESCRIPTION OF THE INVENTION

An aspect of the present specification provides a method comprising: generating, at a computing device, a trajectory corresponding to a two-dimensional touch gesture; generating, at the computing device, a plurality of variations of the trajectory in one or more of two dimensions; extracting, at the computing device, one or more features of the trajectory and the plurality of variations of the trajectory; generating, at the computing device, from the one or more features, one or more machine learning classifiers; and storing, using the computing device, the one or more machine learning classifiers at a memory, such that a machine learning algorithm uses the one or more machine learning classifiers to recognize the two-dimensional touch gesture when receiving touch gesture input.

Another aspect of the present specification provides a computing device comprising: a controller having access to a memory, the controller configured to: generate a trajectory corresponding to a two-dimensional touch gesture; generate a plurality of variations of the trajectory in one or more of two dimensions; extract one or more features of the trajectory and the plurality of variations of the trajectory; generate, from the one or more features, one or more machine learning classifiers; and store, at the memory, the one or more machine learning classifiers, such that a machine learning algorithm uses the one or more machine learning classifiers to recognize the two-dimensional touch gesture when receiving touch gesture input.

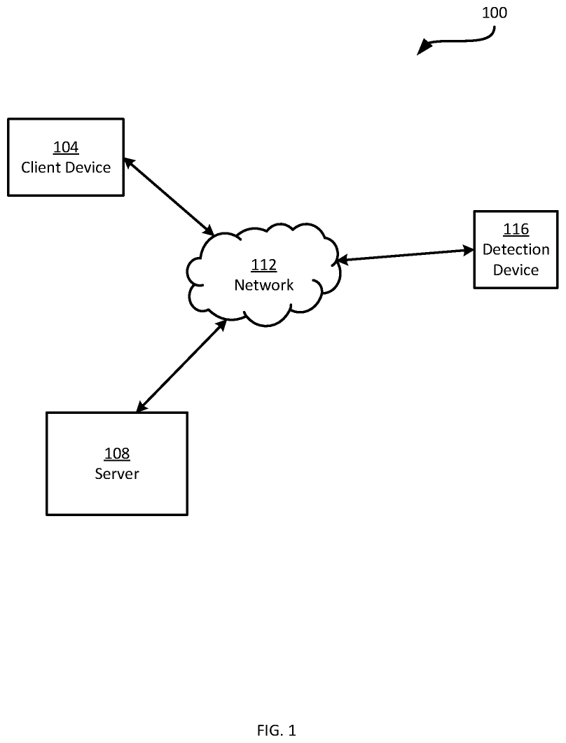

FIG. 1 depicts a system 100 for touch gesture recognition including a client computing device 104 (referred to interchangeably hereafter as a client device 104 and/or as the device 104) interconnected with a server 108 via a network 112. The device 104 can be any one of a variety of computing devices, including a smartphone, a tablet computer and the like. As will be discussed below in greater detail, in the illustrated example, the client device 104 is enabled to detect touch gesture input, e.g. caused by interaction between an operator (not depicted) and a touch gesture sensor at the client device 104, for example a touch screen and the like. It is understood that touch gestures as described herein are generally two-dimensional touch gestures; hence, the terms touch gesture and two-dimensional touch gesture will be used interchangeably hereafter.

The client device 104 and the server 108 are configured to interact via the network 112 to define touch gestures for subsequent recognition, and to generate one or more machine learning classifiers for use in recognizing the defined touch gestures from touch gesture input data collected with any of a variety of touch gesture sensors. The touch gesture input may be collected at the client device 104 itself, and/or at one or more detection devices, for example a detection device 116 depicted in FIG. 1. The detection device 116 can be any one of a variety of computing devices, including a further smartphone, tablet computer or the like, a wearable device such as a smartwatch, a heads-up display, and the like, for example that includes a touch gesture sensor.

In other words, the client device 104 and the server 108 are configured, in some examples, to interact to define touch gestures for recognition and generate the above-mentioned one or more machine learning classifiers enabling the recognition of the defined touch gestures. The client device 104, the server 108, or both, can also be configured to deploy the one or more machine learning classifiers to the detection device 116 (or any set of detection devices) to enable the detection device 116 to recognize the defined touch gestures. To that end, the detection device 116 can be connected to the network 112 as depicted in FIG. 1. In other examples, however, the detection device 116 need not be persistently connected to the network 112, and in some examples the detection device 116 may never be connected to the network 112. Various deployment mechanisms for the above-mentioned one or more machine learning classifiers will be discussed in greater detail herein.

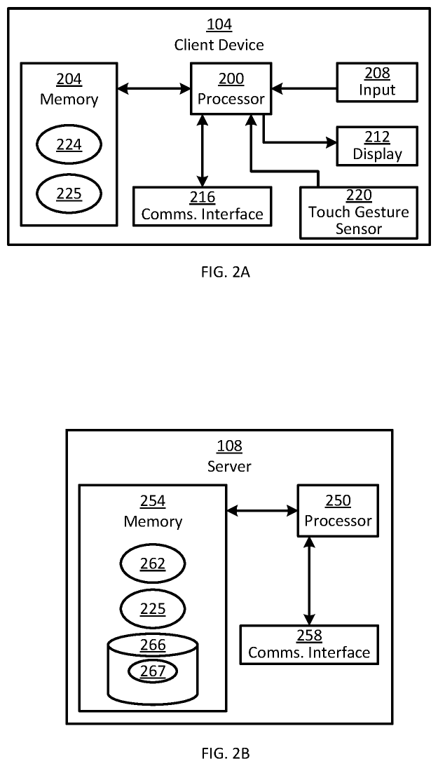

Before discussing the definition of touch gestures, the generation of machine learning classifiers, and the use of the machine learning classifiers to recognize touch gestures from collected touch gesture input within the system 100, certain internal components of the client device 104 and the server 108 will be discussed, with reference to FIGS. 2A and 2B.

Referring to FIG. 2A, the client device 104 includes a central processing unit (CPU), also referred to as a processor 200, interconnected with a non-transitory computer readable storage medium, such as a memory 204. The memory 204 includes any suitable combination of volatile (e.g. Random Access Memory (RAM)) and non-volatile (e.g. read only memory (ROM), Electrically Erasable Programmable Read Only Memory (EEPROM), flash) memory. The processor 200 and the memory 204 each comprise one or more integrated circuits (ICs).

The device 104 also includes an input assembly 208 interconnected with the processor 200, such as a touch screen, a keypad, a mouse, or the like. The input assembly 208 illustrated in FIG. 2A can include more than one of the above-mentioned input devices. In general, the input assembly 208 receives input and provides data representative of the received input to the processor 200. The device 104 further includes an output assembly, such as a display 212 interconnected with the processor 200 (and, in the present example, integrated with the above-mentioned touch screen). The device 104 can also include other output assemblies (not depicted), such as a speaker, an LED indicator, and the like. In general, the display 212, and any other output assembly included in the device 104, is configured to receive output from the processor 200 and present the output, e.g. via the emission of sound from the speaker, the rendering of graphical representations on the display 212, and the like.

The device 104 further includes a communications interface 216, enabling the device 104 to exchange data with other computing devices, such as the server 108 and the detection device 116 (e.g. via the network 112). The communications interface 216 includes any suitable hardware (e.g. transmitters, receivers, network interface controllers and the like) enabling the device 104 to communicate according to one or more communications standards implemented by the network 112. The network 112 comprises any suitable combination of local and wide-area networks, and therefore, the communications interface 216 may include any suitable combination of cellular radios, Ethernet controllers, and the like. The communications interface 216 may also include components enabling local communication over links distinct from the network 112, such as Bluetooth™ connections.

The device 104 also includes a touch gesture sensor 220, including one or more of a touch pad, a touch screen (e.g. a touch screen of the input assembly 208 and/or integrated with the display 212), and the like. The touch gesture sensor 220 is configured to collect touch gesture input representing the movement of a finger (e.g. of an operator of the device 104) and/or a stylus (e.g. as operated by an operator of the device 104) interacting with and/or touching the touch gesture sensor 220, and to provide the collected touch gesture input to the processor 200. The touch gesture input may alternatively be referred to as touch gesture data. In particular, the touch gesture input may comprise a plurality of sampling points, for example as sampled by the touch gesture sensor 220 at intervals and/or at regular intervals and/or according to a sampling rate, each of the sampling points representing a position of a touch input at the touch gesture sensor 220 when a sampling occurs.

Such sampling points may be provided in any suitable two-dimensional coordinates, including, but not limited to a two-dimensional Cartesian system. For example, such sampling points may each comprise an “X” (e.g. an abscissa) coordinate and a “Y” (e.g. an ordinate) coordinate, with respect to an origin defined with respect to the touch gesture sensor 220. A collection and/or set of the sampling points can represent a drawing of a touch gesture, and furthermore a collection of the sampling points in a sequence, as received at the touch gesture sensor 220, may indicate a “trajectory” of the touch gesture, for example with respect to the touch gesture sensor 220.

Indeed, a trajectory, as defined herein, comprises data that indicates a two-dimensional touch gesture, and which may be generated from the touch gesture data corresponding to a drawing of the trajectory and/or the touch gesture. Such a trajectory may include data indicative directions of motion of a touch gesture, as well a path of the touch gesture (e.g. indicating a starting point, and ending point, and an order of points therebetween). For example, data points of a trajectory generally have an order and/or a sequence which represents a first position (e.g. a first data point) and/or a starting position of a touch gesture, a last position (e.g. a last data point) and/or an ending position of the touch gesture and a path of the touch gesture between the first and last positions.

While not depicted, the device 104 may further include one or more motion sensors such as an accelerometer, a gyroscope, a magnetometer, and the like including, but not limited to, an inertial measurement unit (IMU) including each of the above-mentioned sensors. For example, an IMU of the device 104, when present, may include three accelerometers configured to detect acceleration in respective axes defining three spatial dimensions (e.g. X, Y and Z). An IMU of the device 104 may also include gyroscopes configured to detect rotation about each of the above-mentioned axes. An IMU of the device 104 may also include a magnetometer.

The components of the device 104 are interconnected by communication buses (not depicted), and powered by connection to mains power supply, a battery or other power source, over the above-mentioned communication buses or by distinct power buses (not depicted).

The memory 204 of the device 104 stores a plurality of applications, each including a plurality of computer readable instructions executable by the processor 200. The execution of the above-mentioned instructions by the processor 200 causes the device 104 to implement certain functionality, as discussed herein. The applications are therefore said to be configured to perform that functionality in the discussion below.

In the present example, the memory 204 of the device 104 stores a touch gesture definition and/or touch gesture recognition application 224, also referred to herein simply as the application 224. The device 104 is configured, via execution of the application 224 by the processor 200, to interact with the server 108 to create and edit touch gesture definitions for later recognition (e.g. via testing at the client device 104 itself). The device 104 can also be configured via execution of the application 224 to deploy one or more machine learning classifiers resulting from the above creation and editing of touch gesture definitions to the detection device 116. The device 104 is configured, via execution of the application 224 by the processor 200, to recognized touch gestures using one or more machine learning classifiers resulting from the above creation and editing of touch gesture definitions (e.g. as represented by the one or more machine learning classifiers).

In the present example, the memory 204 of the device 104 further stores one or more machine learning algorithms 225, which may be used by the application 224 to generate the above-mentioned one or more machine learning classifiers and/or recognize touch gestures using the above-mentioned one or more machine learning classifiers (e.g. after the one or more machine learning classifiers are generated). However, in other examples, the one or more machine learning algorithms 225 may not be present at the device 104. Alternatively, the one or more machine learning algorithms 225 may be incorporated into the application 224.

In other examples, the processor 200, as configured by the execution of the application 224, and the one or more machine learning algorithms 225 when present, is implemented as one or more specifically-configured hardware elements, such as field-programmable gate arrays (FPGAs) and/or application-specific integrated circuits (ASICs), and the like.

Turning to FIG. 2B, the server 108 includes a central processing unit (CPU), also referred to as a processor 250, interconnected with a non-transitory computer readable storage medium, such as a memory 254. The memory 254 includes any suitable combination of volatile (e.g. Random Access Memory (RAM)) and non-volatile (e.g. read only memory (ROM), Electrically Erasable Programmable Read Only Memory (EEPROM), flash) memory. The processor 250 and the memory 254 each comprise one or more integrated circuits (ICs).

The server 108 further includes a communications interface 258, enabling the server 108 to exchange data with other computing devices, such as the client device 104 and the detection device 116 (e.g. via the network 112). The communications interface 258 includes any suitable hardware (e.g. transmitters, receivers, network interface controllers and the like) allowing the server 108 to communicate according to one or more communications standards implemented by the network 112, as noted above in connection with the communications interface 216 of the client device 104.

Input and output assemblies are not depicted in connection with the server 108. In some examples, however, the server 108 may also include input and output assemblies (e.g. keyboard, mouse, display, and the like) interconnected with the processor 250. In further examples, such input and output assemblies may be remote to the server 108, for example via connection to a further computing device (not depicted) configured to communicate with the server 108 via the network 112.

The components of the server 108 are interconnected by communication buses (not depicted), and powered by a connection to mains power supply, a battery or other power source, over the above-mentioned communication buses or by distinct power buses (not depicted).

The memory 254 of the server 108 stores a plurality of applications, each including a plurality of computer readable instructions executable by the processor 250. The execution of the above-mentioned instructions by the processor 250 causes the server 108 to implement certain functionality, as discussed herein. The applications are therefore said to be configured to perform that functionality in the discussion below. In the present example, the memory 254 of the server 108 stores a touch gesture control application 262, also referred to herein simply as the application 262. The server 108 is configured, via execution of the application 262 by the processor 250, to interact with the client device 104 to generate the above mentioned one or more machine learning classifiers for storage in a repository 266. As such, the memory 254 further stores the one or more machine learning algorithms 225, as an algorithm separate from the application 262 (as depicted) and/or as a component of the application 262.

The one or more machine learning algorithms 225 may comprise any suitable combination of machine learning algorithms and/or deep-learning based algorithms, and/or neural network algorithms and the like, which have been trained and/or configured to generate machine learning classifiers to recognize the two-dimensional touch gestures when receiving touch gesture input, and the like and/or to recognize the two-dimensional touch gesture when receiving touch gesture input based on such generated machine learning classifiers. The one or more machine learning algorithms 225 may include, but is not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like. However, any suitable machine learning algorithm and/or deep learning algorithm and/or neural network algorithm is within the scope of present examples.

In some examples, the server 108 may also configured to generate one or more machine learning classifiers based on script data 267 stored at the repository 266. For example, such script data, while described in more detail below, corresponds to script elements, and the like, which may have been previously generated, and that may be used to generate a trajectory that corresponds to a two-dimensional touch gesture.

For example, as described above, a trajectory comprises data that may be used to indicate a two-dimensional touch gesture, and which may be generated from the script data 267 and/or the touch gesture data corresponding to a drawing of the trajectory. Furthermore, data points of a trajectory generally have an order and/or a sequence which represents a first position (e.g. a first data point) and/or a starting position of a touch gesture, a last position (e.g. a last data point) and/or an ending position of the touch gesture and a path of the touch gesture between the first and last positions.

Indeed, the server 108 may also configured to generate a trajectory corresponding to a two-dimensional touch gesture based on the script data 267 and/or touch gesture data corresponding to a drawing of the trajectory, and the trajectory may be used to generate one or more machine learning classifiers, as described in more detail below.

The server 108 is further configured to employ the one or more machine learning classifiers to recognize touch gestures in received touch gesture input (e.g. from the client device 104), and can also be configured to deploy the one or more machine learning classifiers to other devices such as the client device 104 and the detection device 116 to enable those devices to recognize touch gestures.

In other examples, the processor 250, as configured by the execution of the application 262 and the one or more machine learning algorithms 225, is implemented as one or more specifically-configured hardware elements, such as field-programmable gate arrays (FPGAs) and/or application-specific integrated circuits (ASICs).

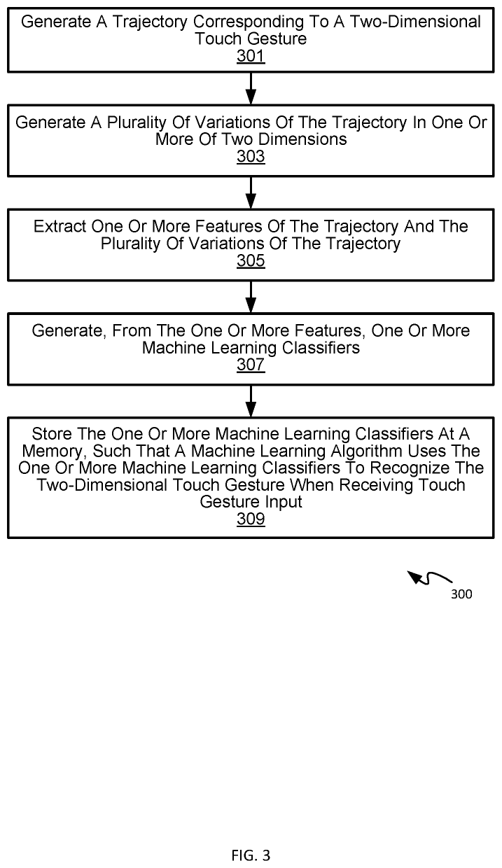

The functionality implemented by the system 100 will now be described in greater detail with reference to FIG. 3.

Attention is now directed to FIG. 3 which depicts a flowchart representative of a method 300 for touch gesture definition as represented by one or more machine learning classifiers. In some examples, the operations of the method 300 correspond to machine readable instructions that are executed by, for example, the server 108, and specifically by the processor 250 of the server 108. In the illustrated example, the instructions represented by the blocks of FIG. 3 are stored at the memory 254, for example, as the application 262. The method 300 is one way in which the server 108 and/or the processor 250 is configured. Furthermore, the following discussion of the method 300 of FIG. 3 will lead to a further understanding of the server 108 and the system 100 and their various components.

Alternatively, the method 300 may be at least partially implemented by the client device 104, and specifically by the processor 200 of the device 104. Indeed, the method 300 may be performed by any suitable computing device.

However, it is understood that the server 108 and/or the device 104 and/or the system 100 and/or the method 300 may be varied, and need not work exactly as discussed herein in conjunction with each other, and that such variations are within the scope of the present specification.

Furthermore, the method 300 need not be performed in the exact sequence as depicted and likewise various blocks may be performed in parallel rather than in sequence. Accordingly, the elements of method 300 are referred to herein as “blocks” rather than “steps”.

At a block 301, the processor 250 generates a trajectory corresponding to a two-dimensional touch gesture.

In some examples, the processor 250 may generate the trajectory by: receiving touch gesture data corresponding to a drawing of the trajectory; and converting the touch gesture data to the trajectory. For example, the touch gesture data may be received from the client device 104 implementing the application 224; specifically, in these examples, the client device 104 may generate touch gesture data corresponding to a drawing of the trajectory, and transmit the touch gesture data to the server 108 via the communications interface 216 and the network 112. Similarly, in these examples, the server 108, and the processor 250 may receive the touch gesture data via the communications interface 258 and the network 112.

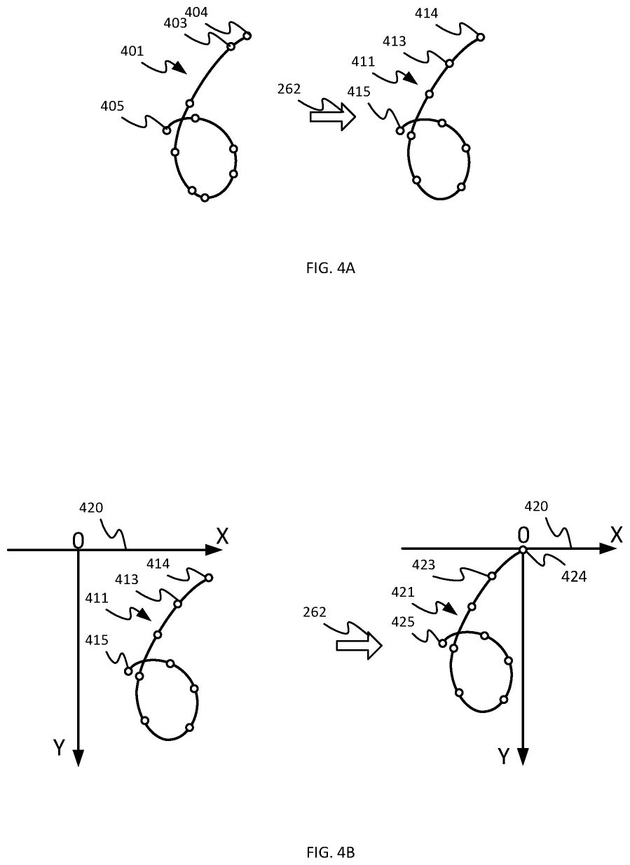

When the processor 250 generates the trajectory by: receiving touch gesture data corresponding to a drawing of the trajectory, and converting the touch gesture data to the trajectory, the processor may convert the touch gesture data to the trajectory by one or more of: removing an off-set from the touch gesture data; and evenly distributing sampling points in the touch gesture data. Such removing an off-set and distributing sample points may alternatively be referred to as pre-processing and is described in more detail below with respect to FIG. 4A and FIG. 4B.

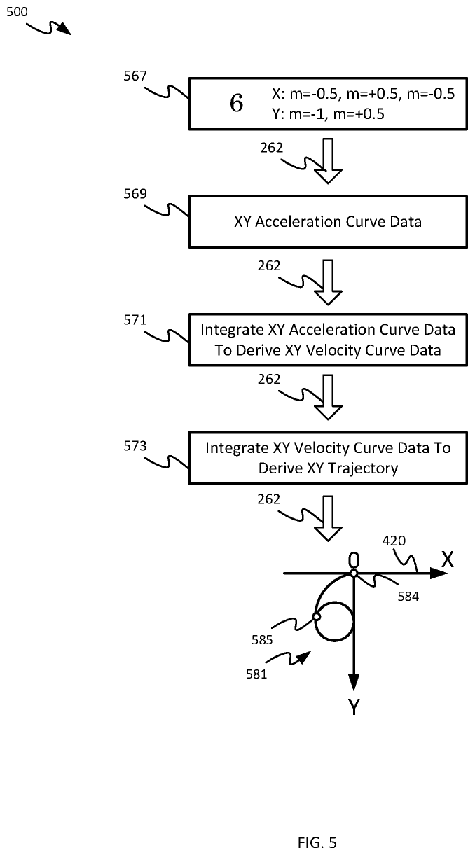

In other examples, the processor 250 may generate the trajectory by: receiving script data defining the trajectory; and converting the script data to the trajectory. For example, the processor 250 may receive (and/or retrieve), from the repository 266, a subset of the script data 267 that corresponds to the trajectory. Alternatively, the processor 250 may receive (and/or retrieve) script data that corresponds to the trajectory from another device, including, but not limited to, the client device 104. Specific examples of generating the trajectory using script data are described below with respect to FIG. 5.

At a block 303, the processor 250 generates, at the computing device, a plurality of variations of the trajectory in one or more of two dimensions.

In some examples, the processor 250 generates the plurality of variations of the trajectory by one or more of: scaling the trajectory in one or more of the two dimensions; rotating the trajectory; extending one or more portions of the trajectory; one or more of cropping and cutting the one or more portions of the trajectory; distorting the trajectory in one or more of the two dimensions; elastically distorting the trajectory in one or more of the two dimensions; applying one or more perspectives to the trajectory in one or more of the two dimensions; deforming at least a portion of the trajectory; and distorting at least a portion of the trajectory.

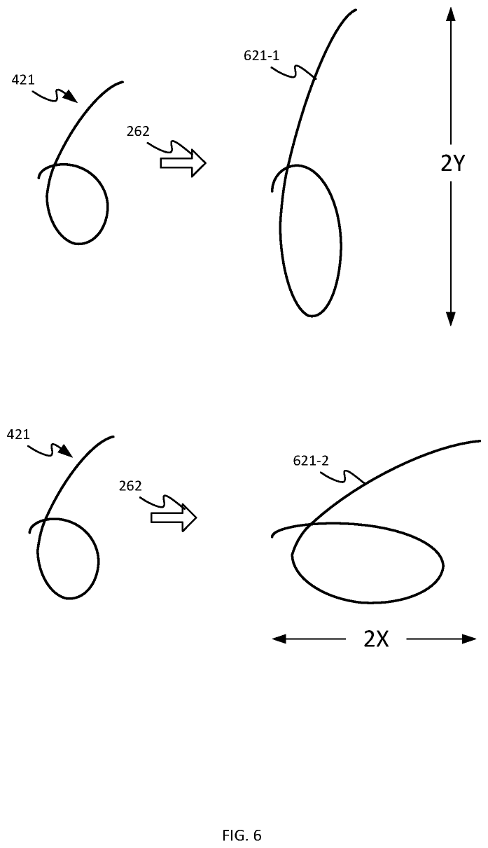

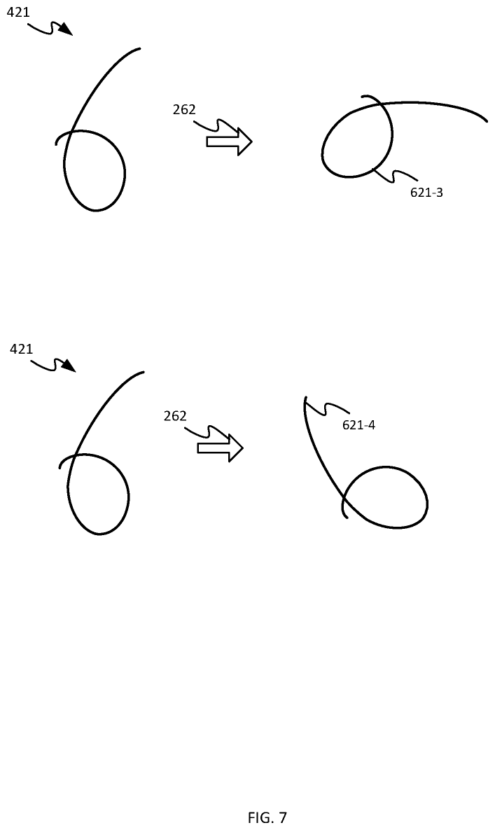

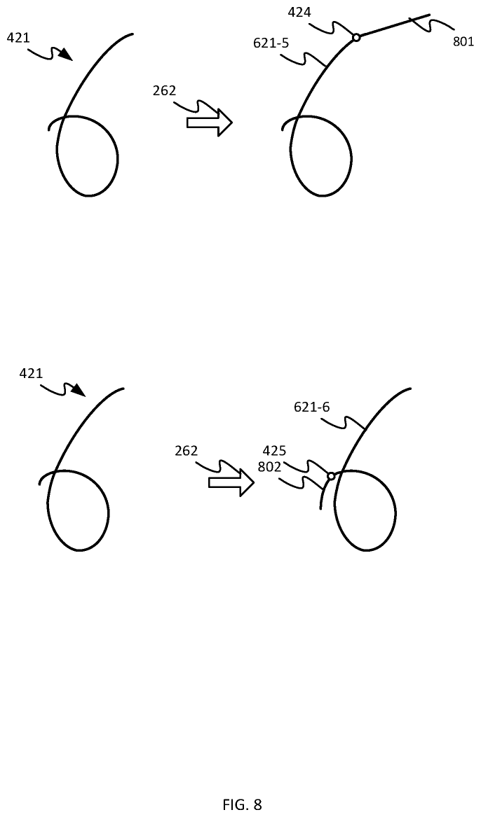

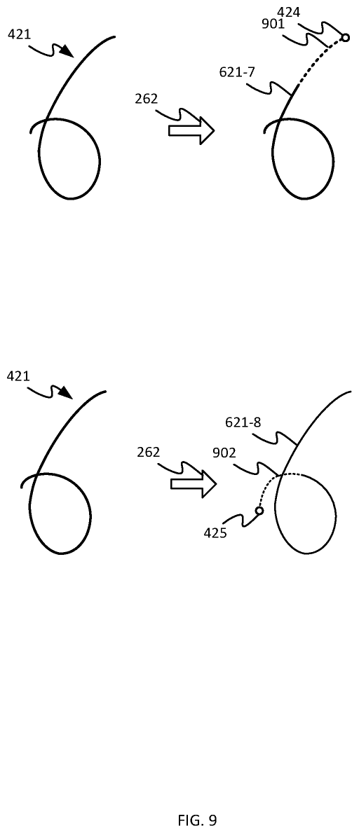

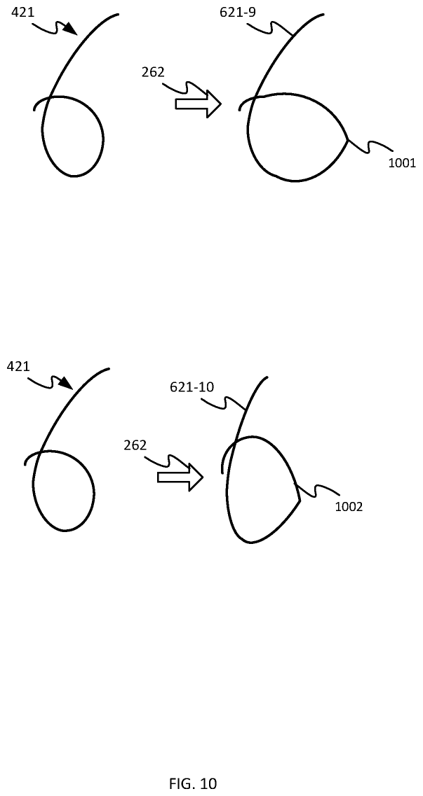

Specific examples of generating the plurality of variations of the trajectory are described below with respect to FIG. 6, FIG. 7, FIG. 8, FIG. 9 and FIG. 10.

At a block 305, the processor 250 extracts one or more features of the trajectory and the plurality of variations of the trajectory.

In some examples, the processor 250 extracts the one or more features of the trajectory and the plurality of variations of the trajectory by, for the trajectory and the plurality of variations of the trajectory: sampling a fixed number of data points representing the trajectory or a variation of the trajectory, the fixed number of data points distributed along the trajectory or the variation of the trajectory, the data points comprising respective coordinates in a given coordinate system; and determining one or more of: a normalized sequence of changes in angle between adjacent data points along the trajectory or the variation of the trajectory; a normalized histogram of the normalized sequence; a normalized first coordinate histogram of normalized first coordinates, for a first direction in the given coordinate system; and a normalized second coordinate histogram of normalized second coordinates, for a second direction in the given coordinate system.

In some of these examples, the features comprise, for the trajectory and the plurality of variations of the trajectory, one or more of: the normalized first coordinates; the normalized second coordinates; the normalized first coordinate histogram; the normalized second coordinate histogram; the normalized sequence of the changes in the angle; and the normalized histogram for the normalized sequence.

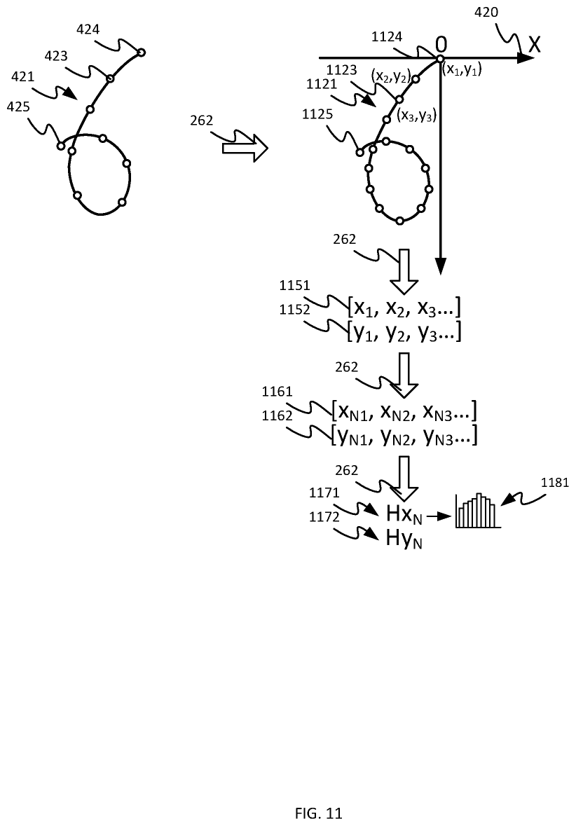

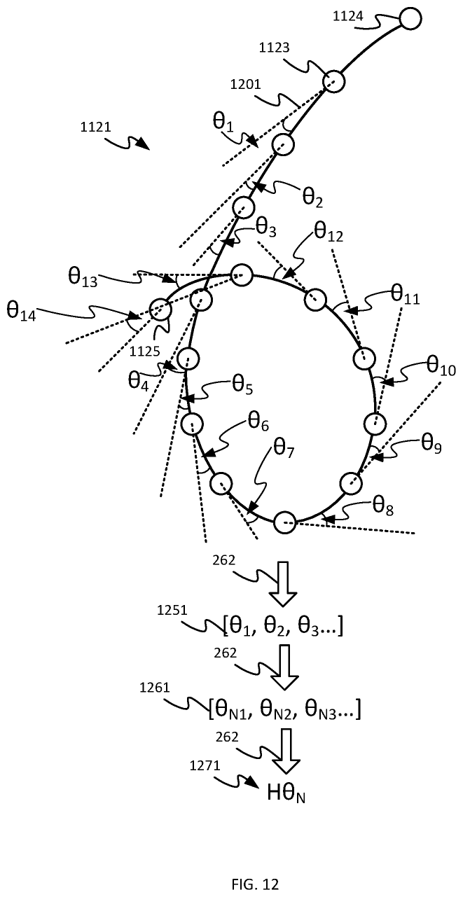

Specific examples of extracting the one or more features of the trajectory and the plurality of variations of the trajectory are described below with respect to FIG. 11 and FIG. 12.

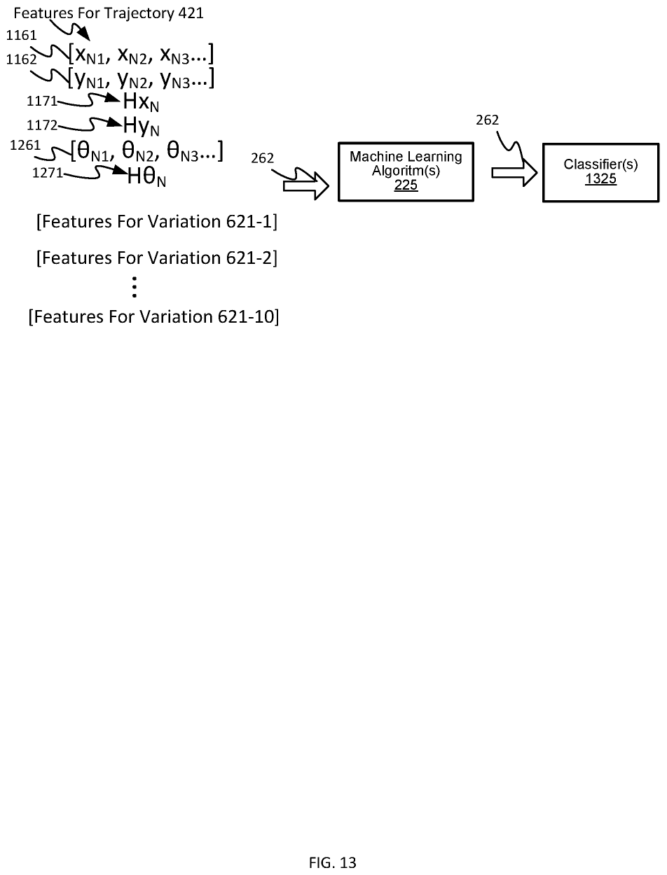

At a block 307, the processor 250 generates, from the one or more features, one or more machine learning classifiers. For example, the one or more machine learning classifiers may be generated by training the one or more machine learning algorithms 225 using the features. Specific examples of generating one or more machine learning classifiers are described below with respect to FIG. 13.

At a block 309, the processor 250 stores the one or more machine learning classifiers at a memory, such that a machine learning algorithm (such as the one or more machine learning algorithms 225) uses the one or more machine learning classifiers to recognize the two-dimensional touch gesture when receiving touch gesture input. For example, the processor 250 generally has access to a memory which may be used to store the one or more machine learning classifiers; the memory to which the processor 250 has access may be a local memory, such as the memory 254, or a remote memory, such as the memory 204 (e.g., the processor 250 may have access to a memory for storing the one or more machine learning classifiers by virtue of communicating with a device that includes such a memory via the interface 258 and/or a network).

In some examples, the processor 250 may store the one or more machine learning classifiers at a memory in association with a label identifying the two-dimensional touch gesture. Hence, for example, when the two-dimensional touch gesture is recognized, the label may be used as input to an application to instruct the application how to respond to the two-dimensional touch gesture. In some examples, the label is received with the touch gesture data from the client device 104.

In some examples, the processor 250 may store the one or more machine learning classifiers at the memory 254, for example at the repository 266. In these examples, the processor 250 may later receive touch gesture input, for example from the client device 104 and/or the detection device 116, such that the one or more machine learning algorithms 225 uses the one or more machine learning classifiers stored at the memory 254 to recognize the two-dimensional touch gesture from the received touch gesture input. The processor 250 may then transmit an associated label back to the client device 104 and/or the detection device 116 to instruct an application at the client device 104 and/or the detection device 116 how to respond to the two-dimensional touch gesture.

However, in other examples, the processor 250 may store the one or more machine learning classifiers at a memory by transmitting the one or more machine learning classifiers to one or more devices that receive the touch gesture input and execute a machine learning algorithm (e.g. one or more of the machine learning algorithms 225) to recognize touch gesture input as a two-dimensional touch gesture. The one or more machine learning classifiers may be transmitted with an associated label. For example, the processor 250 may transmit the one or more machine learning classifiers (and an associated label) to the client device 104 and/or the detection device 116, for example for storage at the memory 204 (and/or a memory of the detection device 116); in these examples, the client device 104 and/or the detection device 116 uses that the one or more machine learning algorithms 225 stored at the memory 204 (and/or a memory of the detection device 116) and the one or more machine learning classifiers stored at the memory 204 (and/or a memory of the detection device 116) to recognize the two-dimensional touch gesture from the received touch gesture input. Such recognition may result in an associated label instructing an application at the client device 104 and/or the detection device 116 how to respond to the two-dimensional touch gesture.

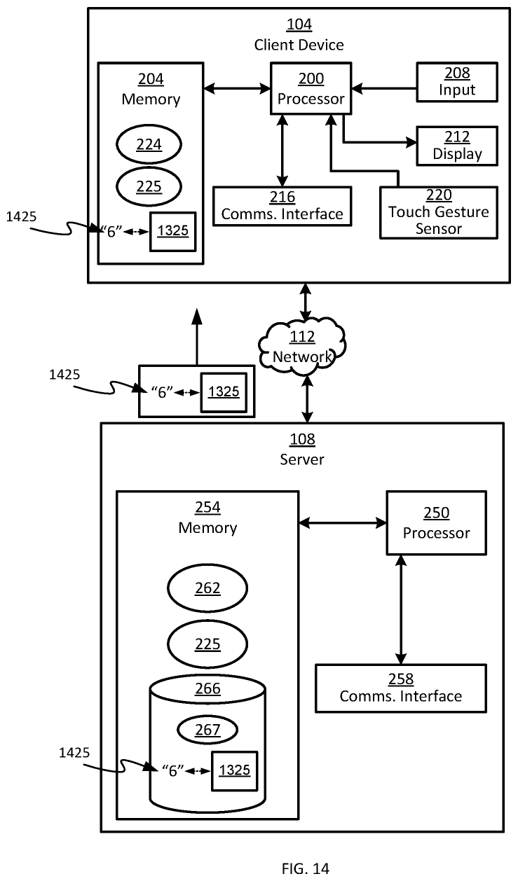

Specific examples of storing one or more machine learning classifiers at a memory are described below with respect to FIG. 14.

The method 300 is next described in more detail.

Attention is next directed to FIG. 4A and FIG. 4B, each of which depict aspects of an example of the block 301 for generating a trajectory. While the processor 250 is not depicted, it is understood that the aspects of the block 301 of the method 300 depicted in FIG. 4A and FIG. 4B are being implemented by the processor 250 and/or the server 108 and/or another suitable computing device (e.g. the client device 104) executing the application 262 and/or a similar application (e.g. the application 224). Furthermore, the aspects of the block 301 depicted in FIG. 4A and FIG. 4B are understood to be one example of generating a trajectory and any suitable process for generating a trajectory is within the scope of the present specification.

In particular, touch gesture data 401 is depicted in FIG. 4A and FIG. 4B that may be received at the server 108 from the client device 104. For example, an operator of the client device 104 may be interacting with the touch gesture sensor 220 while the client device 104 is implementing the application 224, to communicate with the server 108 to train the server 108 and/or the device 104 for touch gesture recognition. In the depicted example, the touch gesture data 401 corresponds to a drawing of a trajectory and/or a touch gesture which is to be generated at the block 301.

In particular, as depicted, the touch gesture data 401 corresponds to the number “6”. Hence, for example, the operator of the client device 104 may have interacted with the touch gesture sensor 220 (e.g. a touch screen) to draw the number “6” in two-dimensions at the touch gesture sensor 220. The drawing of the number “6” may represent a two-dimensional touch gesture that the operator wishes to train the server 108 and/or the client device 104 and/or the detection device 116 to recognize.

As seen on the left-hand side of FIG. 4A, the touch gesture data 401 is represented by sampling points 403 including a first sampling point 404 and a last sampling point 405; while only three sampling points 403, 404, 405 are indicated, it is understood from FIG. 4A that the touch gesture data 401 includes nine sampling points 403, including the first sampling point 404 and the last sampling point 405. However, the touch gesture data 401 includes any suitable number sampling points, including, but not limited to tens to hundreds of sampling points 403. Indeed, a number of sampling points 403 may depend on a sampling rate at the touch gesture sensor 220, and also a rate of movement of a finger (and/or a stylus) of an operator of the device 104 at the touch gesture sensor 220.

Furthermore, the sampling points 403 are generally associated with an order and/or a sequence, starting with the first sampling point 404 and ending with the last sampling point 405, with the remaining sampling points 403 being in an as-sampled order in the sequence. For example, the first sampling point 404 in the sequence is generally the first point sampled by the touch gesture sensor 220, a second sampling point 403 in the sequence is generally the second point sampled by the touch gesture sensor 220, a third sampling point 403 in the sequence is generally the third point sampled by the touch gesture sensor 220, etc., and the last sampling point 405 in the sequence is generally the last point sampled by the touch gesture sensor 220.

Each sampling point 403 represents a two-dimensional coordinate (e.g. an XY coordinate such as (x, y) coordinate) indicative of the position of a finger (and/or a stylus) of the operator at the touch gesture sensor 220 at various time intervals (e.g. as sampled at the touch gesture sensor 220 at a sampling rate), with the first sampling point 404 indicating a starting position of the finger (and/or the stylus) and the last sampling point 405 indicating an ending position of the finger (and/or the stylus).

As depicted, the sampling points 403 of the touch gesture data 401 are unevenly distributed; hence, in some examples, as depicted on the right-hand side of FIG. 4A, the processor 250 may evenly distribute the sampling points 403, for example in updated touch gesture data 411, as evenly distributed sampling points 413, including an evenly distributed first sampling point 414 and evenly distributed last sampling point 415. For example, as depicted, the nine sampling points 403 are evenly redistributed along the trajectory 411 as evenly distributed sampling points 413 (e.g. the sampling points 411 are evenly distributed between the first sampling point 414 and the evenly distributed last sampling point 415). In particular, while the positions of the evenly distributed first sampling point 414 and the evenly distributed last sampling point 415 are unchanged relative to the first sampling point 404 and the last sampling point 405, the positions of the remaining sampling points 413 may change relative to corresponding sampling points 403.

Furthermore, the processor 250 may remove an off-set from the touch gesture data 401. For example, as depicted on the left-hand side of FIG. 4B, when the updated touch gesture data 411 are shown on an XY and/or a Cartesian coordinate system 420 (which is referred to hereafter interchangeably as the given coordinate system 420), the updated touch gesture data 411 may not intersect an origin (e.g. depicted as “0” in FIG. 4B).

As also depicted in FIG. 4B, the processor 250 may offset the evenly distributed first sampling point 414 at the origin to remove an off-set; for example, as depicted on the right-hand side of FIG. 4B, the updated touch gesture data 411 are offset (e.g. via the application 262) to generate a trajectory 421 comprising offset sampling points 423 including a first offset sampling point 424 at the origin, and a last offset sampling point 425.

In particular, the first offset sampling point 424 corresponds to the evenly distributed first sampling point 414 but offset in an “X” direction and/or a “Y” direction to the origin of the given coordinate system 420. The remaining sampling points 423, including the last offset sampling point 425, each correspond to respective evenly distributed sampling points 413, but offset in the given coordinate system 420 by the same offset as the first offset sampling point 424.

Hence, for example, the first offset sampling point 424 has coordinates of (0,0), with each of the other offset sampling points 423 having coordinates (x,y) in the given coordinate system 420. Furthermore, an order and/or a sequence of the sampling points 423 represents a direction and/or a path in which the original touch gesture data 411 was sampled and/or in which the touch gesture represented by the touch gesture data 401 was drawn at the touch gesture sensor 220.

In addition, the sampling points 423 are also associated with an order and/or a sequence, similar to the sequence of the sampling points 403. For example, the first sampling point 424 is the first point in the sequence, a second sampling point 423 generally corresponds to the second sampling point 403 of the sampling points 403, etc.

While the redistribution and offset of the sampling points 403 are described in a particular order to generate the trajectory 421, the redistribution and offset of the sampling points 403 may occur in any suitable order, including, but not limited to, first applying an offset, for example based on the first sampling point 404 and then evenly distributing the sampling points 403. Furthermore, while the offset is described with respect to a first sampling point being offset to the origin of the given coordinate system 420, the offset may be determined for any suitable sampling point (e.g. a last sampling point) to any suitable position of the given coordinate system 420.

It is further understood that, as depicted, the “6” was drawn starting from the first sampling point 404 and ending at the last sampling point 405. Hence, once the sampling points 403 are evenly distributed and offset. The sequence of sampling points 413, from the first sampling point 414 to the last sampling point 415 represent movement of the finger (and/or stylus) of an operator interacting with the touch gesture sensor 220, and hence the trajectory 421 generically represents such an interaction.

While touch gesture data 401, 411 and the trajectory 421 are depicted with lines between their respective sampling points, such lines may not be present but are shown merely to provide a convenient graphical indication of the touch gesture data 401, 411 and the trajectory 421.

In some examples described hereafter, trajectories may be represented by the script data 267. For example, attention is next directed to FIG. 5 which depicts another aspect of an example of the block 301 for generating a trajectory. In particular FIG. 5 depicts a method 500 generating a trajectory based on script data 567; the script data 567 may comprise a subset of the script data 267. While the processor 250 is not depicted, it is understood that the aspects of the block 301, as represented by the method 500 depicted in FIG. 5 are being implemented by the processor 250 and/or the server 108 and/or another suitable computing device (e.g. the client device 104) executing the application 262 and/or a similar application (e.g. the application 224).

Furthermore, the aspects of the block 301 depicted in FIG. 5 are understood to be one example of generating a trajectory and any suitable process for generating a trajectory is within the scope of the present specification.

In particular, the script data 567 comprises script elements representing a sequence of motion indicators of the number “6”. The script elements may be used to generate synthetic motion data defining a trajectory representing the number 6. Such script elements and the generation of synthetic motion data defining a trajectory therefrom are described in more detail in Applicant's co-pending PCT Application No. PCT/IB2018/055402 filed on Jul. 19, 2018, the contents of which are incorporated herein by reference.

In the depicted example, the script elements of the script data 567 represent a sequence of motion indicators of the number “6”. For example, the sequence of normalized “X” script elements m=−0.5, m=+0.5, m=−0.5 of the script data 567, represent segments of relative and/or normalized motion and/or movements along an X (e.g. abscissa) axis of the given coordinate system 420 as the number “6” is being drawn. For example, starting from an origin of the given coordinate system 420, as the number “6” is being drawn, motion is initially in a negative direction (e.g. represented by −0.5); when a normalized value of −0.5 is reached, motion reverses to a positive direction (e.g. represented by +0.5); and when a normalized value of 0 is reached (e.g. −0.5+0.5), motion reverses back to a negative direction (e.g. represented by the second −0.5) until motion stops when the normalized value of −0.5 is again reached.

Similarly, the sequence of normalized “Y” script elements m=−1, m=+0.5 of the script data 567, represent segments of relative and/or normalized motion and/or movements along a Y (e.g. ordinate) axis of the given coordinate system 420 as the number “6” is being drawn. For example, starting from an origin of the given coordinate system 420, as the number “6” is being drawn, motion is initially in a negative direction (e.g. represented by −1); when a normalized value of −1 is reached, motion reverses to a positive direction (e.g. represented by +0.5); and when a normalized value of −0.5 is reached (e.g. −1+0.5), motion stops.

As best described in Applicant's co-pending PCT Application No. PCT/IB2018/055402 filed on Jul. 19, 2018, the script data 567 may be used to generate XY acceleration curve data 569, for example representing acceleration of an accelerometer being moved to “draw” the number “6” in a plane. The XY acceleration curve data 569 may be generated on the basis of a relationship between distance, acceleration and time, as will be familiar to those skilled in the art of:

d=½at²+vₒt+dₒ

where vₒ is an initial velocity and dₒ is an initial displacement. In the present example, initial velocity and initial displacement are assumed to be zero, and the relationship is therefore simplified as follows:

d=½at²

In the above equation, “d” represents displacement, as defined by the script elements for a segment (e.g. each the script element “m” represents a respective distance “d”), “a” represents acceleration, and “t” represents time. Acceleration may be assigned arbitrarily, for example as a single common acceleration for each movement as defined by the script elements “m” for a segment. The time for each movement therefore remains unknown. By assigning equal accelerations to each movement, the acceleration component of the relationship can be removed, for example by forming the following ratio for each pair of adjacent movements:

$$\frac{{d}_{1}}{{d}_{2}} = {( \frac{{t}_{1}}{{t}_{2}} )}^{2}$$

The ratios of displacements are known from the script elements “m” defining the touch gesture. An arbitrary total duration (i.e. sum of all time periods for the movements), such as two seconds (though any of a variety of other time periods may also be employed) may be assumed such that, from the set of equations defining ratios of time periods (e.g. as generated by adjacent “m” script elements being set to d₁ and d₂), and the equation defining the sum of all time periods, the number of unknowns (the time period terms, specifically) matches the number of equations, and the set of equations can be solved for the value of each time period, for example by the processor 250 and/or the server 108.

Once the time periods for each movement, represented by the script elements “m” are determined, the XY acceleration curve data 569 may be generated, by assuming that an accelerometer response curve is sinusoidal (e.g. sinusoidal for each positive “m” segment, and an inverse of a sinusoidal curve for each negative “m” segment), and further by merging together continuous movements and/or merging together adjacent acceleration response curves when adjacent movements have different signs (e.g. an m=+0.5 segment and an m=−0.5 segment have different signs). In any event, the end goal is to simulate accelerometer response data and/or to produce synthetic data that accurately simulates data that would be produced by an accelerometer being moved to “draw” the number “6” in a plane, and as best described in Applicant's co-pending PCT Application No. PCT/IB2018/055402 filed on Jul. 19, 2018.

For example, accelerations are determined for each half-wave (i.e. each half of a movement, or each merged portion, as applicable, assuming that the response curve of an accelerometer is sinusoidal). As noted above, accelerations were initially set to a common arbitrary value for determination of time periods. Therefore, given that time periods have been determined, amplitudes for each half-wave can be determined, for example according to the following:

$${a}_{1} = {a}_{max} \times sin ( \frac{π T}{{t}_{1}} ) , \\ where {a}_{max} = \frac{2 d}{{t}^{2}}$$

In the above equation, “a” is the amplitude for a given half-wave, “T” is the sum of all time periods, and “t” is the time period corresponding to the specific half-wave under consideration. When each half-wave in a cluster of sinusoids of has been fully defined by a time period and an amplitude as above, the processor 250 repeats the process for any remaining clusters, the process is then repeated for any remaining dimensions of the touch gesture (e.g. for the motion indicators defining movements in the Y direction after those defining movements in the X direction have been processed). The result, in each dimension, is a series of time periods and accelerations that define synthetic accelerometer data corresponding to the motion indicators. The XY acceleration curve data 569 represents such synthetic accelerometer data.

The XY acceleration curve data 569 may be integrated 571 to derive XY velocity curve data. Similarly, the XY velocity curve data may be integrated 573 to derive an XY trajectory 581. For example, as depicted, the trajectory 581 comprises the number “6” drawn on the given coordinate system 420, with a first point 584 at an origin of the given coordinate system 420 and including a last point 585. It is understood that line between the first point 584 and the last point 585 represents movement from the first point 584 and the last point 585, and furthermore the trajectory 581 may include any suitable number of points between the first point 584 and the last point 585, for example as generated by the processor 250.

Furthermore, the trajectory 581 may be normalized as described above, though the first point 584 may be arbitrarily set to the origin of the given coordinate system 420.

Attention is next directed to FIG. 6, FIG. 7, FIG. 8, FIG. 9 and FIG. 10, each of which depicts aspects of the block 303 for generating a plurality of variations of a trajectory. While the processor 250 is not depicted, it is understood that the aspects of the block 303 depicted in FIG. 6, FIG. 7, FIG. 8, FIG. 9 and FIG. 10 are being implemented by the processor 250 and/or the server 108 and/or another suitable computing device (e.g. the client device 104) executing the application 262 and/or a similar application (e.g. the application 224).

Furthermore, the aspects of the block 303 depicted in FIG. 6, FIG. 7, FIG. 8, FIG. 9 and FIG. 10 are understood to be particular examples of generating a plurality of variations of a trajectory and any suitable process for generating a plurality of variations of a trajectory is within the scope of the present specification.

While sampling points 423 of the trajectory 421, or corresponding points of generated variations are not depicted in FIG. 6, FIG. 7, FIG. 8, FIG. 9 and FIG. 10, such points are nonetheless understood to be present.

In particular, each of FIG. 6, FIG. 7, FIG. 8, FIG. 9 and FIG. 10 depict variations of the trajectory 421 being generated in one or more of two dimensions.

For example, FIG. 6 depicts a variation 621-1 being generated from the trajectory 421 by scaling and/or increasing the trajectory 421 by a factor of “2” in a “Y” direction, with no scaling occurring in an “X” direction. Similarly, FIG. 6 further depicts a variation 621-2 being generated from the trajectory 421 by scaling and/or increasing the trajectory 421 by a factor of “2” in a “X” direction, with no scaling occurring in a “Y” direction. However, other scaling factors may be used in the “X” direction and/or the “Y” direction, and further scaling may occur in one or both directions.

In another example, FIG. 7 depicts a variation 621-3 being generated from the trajectory 421 by rotating the trajectory 421 for example clockwise by a given angle. Similarly, FIG. 7 further depicts a variation 621-4 being generated from the trajectory 421 by rotating the trajectory 421 for example counterclockwise by the given angle.

In another example, FIG. 8 depicts a variation 621-5 being generated by extending the trajectory 421 by extending one or more portions of the trajectory 421 and in particular adding an extension 801 extending from the first sampling point 424 (e.g. which may also be referred to as extending a portion that includes the first sampling point 424). Similarly, FIG. 8 depicts a variation 621-6 being generated by extending the trajectory 421 by extending one or more portions of the trajectory 421 and in particular adding an extension 802 extending from the last sampling point 425 (e.g. which may also be referred to as extending a portion that includes the last sampling point 425).

In another example, FIG. 9 depicts a variation 621-7 being generated by cropping and/or cutting one or more portions from the trajectory 421 and in particular cropping a portion 901 that includes the first sampling point 424. Similarly, FIG. 9 depicts a variation 621-8 being generated by cropping and/or cutting one or more portions from the trajectory 421 and in particular cropping and/or cutting a portion 902 that includes the last sampling point 425. The terms cropping and cutting may be used interchangeably, each referring to removing a portion from a trajectory that includes a first sampling point or a last sampling point.

In another example, FIG. 10 depicts a variation 621-9 being generated by distorting the trajectory 421 in one or more of two dimensions, and in particular extending a portion 1001 in an X-direction, and not distorting the remaining portions of the trajectory. Similarly, FIG. 10 depicts a variation 621-10 being generated by cropping and/or cutting from the trajectory 421 by compressing a portion 1002 in an X-direction, and not distorting the remaining portions of the trajectory.

The variations 621-1, 621-2, 621-3, 621-4, 621-5, 621-6, 621-7, 621-8, 621-9, 621-10 are interchangeably referred to hereafter, collectively, as the variations 621, and, generically, as a variation 621.

Furthermore, while specific examples of the variations 621 have been shown, any suitable number of variations 621 may be generated. For example, variations 621 with different scaling, different rotations, different extensions, different cropping and/or cutting and different distortions may be generated. Furthermore, variations 621 may be generated that include, but are not limited to, elastic distortions of the trajectory 421, applying one or more perspectives to the trajectory 421 in one or more of the two dimensions, deforming at least a portion of the trajectory 421 and distorting at least a portion of the trajectory 421.

Furthermore, while generating variations 621 of the trajectory 421 have been described, when the trajectory 581 is generated, variations of the trajectory 581 are also generated. Indeed, in some examples, both the trajectories 421, 581 may be generated, as well as variations of each.

Attention is next directed to FIG. 11, and FIG. 12, each of which depicts aspects of the block 305 for extracting features from a trajectory (and variations of a trajectory). While the processor 250 is not depicted, it is understood that the aspects of the block 305 depicted in FIG. 11 and FIG. 12 are being implemented by the processor 250 and/or the server 108 and/or another suitable computing device (e.g. the client device 104) executing the application 262 and/or a similar application (e.g. the application 224). Furthermore, the aspects of the block 305 depicted in FIG. 11 and FIG. 12 are understood to be one example of extracting features from a trajectory (e.g. the trajectory 421) and variations of a trajectory (e.g. the variations 621) and any suitable process for extracting features from a trajectory and variations of a trajectory is within the scope of the present specification.

Furthermore, while the example of FIG. 11 and FIG. 12 are described with respect to extracting features from the trajectory 421, it is understood that the aspects of the described example may be applied to each of the variations 621. Similarly, when the trajectory 581 and variations of the trajectory 581 are generated, aspects of the described example may be applied to each of the trajectory 581 and variations of the trajectory 581.

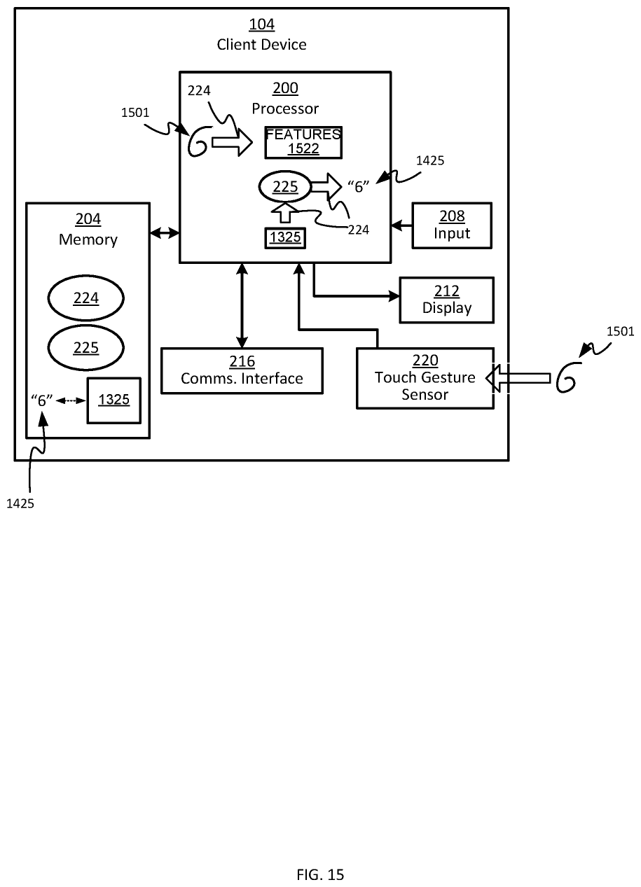

Attention is first directed to FIG. 11 in which a fixed number of data points representing the trajectory 421 are sampled from the trajectory 421. For example, as depicted, the trajectory 421 includes nine sampling points 423, including the first sampling point 424 and the last sampling point 425. As the number of sampling points 423 may depend on a sampling rate at the touch gesture sensor 220 (e.g. and also a rate of movement of a finger (and/or a stylus) of an operator of the device 104, the number of sampling points 423 may vary between trajectories and/or between touch gesture data. Hence, for consistency, the trajectory 421 is sampled using a fixed number of data points, which is fixed, for example, when other types of gestures are being trained at the server 108 and/or when the one or more machine learning algorithms 225 later uses one or more machine learning classifiers (e.g. as generated at the block 307) to recognize a two-dimensional touch gesture when receiving touch gesture input, described in more detail below with respect to FIG. 15.

As depicted, in FIG. 11, a trajectory 1121 is determined which is similar to the trajectory 421, and indeed represents the trajectory 421 but sampled using a fixed number of data points 1123 distributed along the trajectory 1121. In particular, as depicted, the data points 1123 of the trajectory 1121 includes a first data point 1124, having a same and/or similar position as the first sampling point 424, and a last data point 1125, having a same and/or similar position as the last sampling point 425, with the remaining data points 1123 evenly distributed between the first data point 1124 and the last data point 1125.

In addition, the data points 1123 are also associated with an order and/or a sequence, similar to the sequence of the sampling points 403 and/or the sampling points 423. For example, the first data point 1124 is the first data point in the sequence, a second data point 1123 in the sequence is the next data point 1123 after the first data point 1124 along the trajectory 1121 (and/or the second data point 1123 is the data point adjacent the first data point 1124, along a path represented by the trajectory 1121), etc., and the last data point 1125 is the last data point in the sequence. Indeed, the sequence of the data points 1123 generally corresponds to the sequence of the sampling points 423 and/or a path of the trajectory 1121.

While as depicted, the fixed number of the data points 1123 is fifteen data points, the fixed number may be any suitable number including tens to hundreds to thousands of the data points 1123, as long as the fixed number is used when sampling other trajectories and/or variations of trajectories (including, but not limited to the variations 621) across the system 100, as well as trajectories determined from touch gesture input in the system 100 that is to be used by the one or more machine learning algorithms 225 (e.g. using one or more machine learning classifiers as generated at the block 307) to recognize a two-dimensional touch gesture).

It is further understood that the data points 1123 comprise respective coordinates in the given coordinate system 420. For example, assuming that the sampling points 423 of the trajectory 421 are in the coordinate system 420 (e.g. as depicted in FIG. 4), the data points 1123 are also in the given coordinate system 420 with, for example, the first data points 1124 having coordinates of (0,0) (e.g. at the origin, and/or the same coordinates as the first sampling point 424), and the last data point 1125 having the same coordinates as the last sampling point 425 of the trajectory 421.

For example, as depicted, the coordinates of the first three data points of the trajectory 1121 are represented in FIG. 11 as: (x₁, y₁), (x₂, y₂), (x₃, y₃), etc. For example, the coordinates (x₁, y₁) of the first data point 1124 are generally (0,0), or x₁=0, and y₁=0.

As depicted, the x coordinates and/or first coordinates x₁, x₂, x₃ . . . may be extracted from the coordinates (x₁, y₁), (x₂, y₂), (x₃, y₃) . . . , and sorted into first coordinates 1151 (e.g. [x₁, x₂, x₃ . . . ] and second coordinates 1152 ((e.g. [y₁, y₂, y₃ . . . ]); for example each of the coordinates 1151, 1152 may be in a same sequence as the coordinates (x₁, y₁), (x₂, y₂), (x₃, y₃) . . . .

As depicted, the first coordinates 1151 are normalized into corresponding normalized first coordinates 1161 (e.g. [x_{N1}, x_{N2}, x_{N3} . . . ]), and the second coordinates 1152 are normalized into corresponding normalized second coordinates 1162 (e.g. [y_{N1}, y_{N2}, y_{N3} . . . ]); for example, each of the normalized coordinates 1161, 1162 may be in a same sequence as the coordinates (x₁, y₁), (x₂, y₂), (x₃, y₃) . . . .

The normalized first coordinates 1161 may be normalized to values from −1 and +1, using any suitable normalization process. Similarly, the normalized second coordinates 1162 may be normalized to values from −1 and +1, using any suitable normalization process (e.g. independent from the normalized first coordinates 1161).

As depicted, the normalized first coordinates 1161 are sorted into a normalized first coordinate histogram 1171 (e.g. H_{xN}), for example by sorting and counting similar and/or same normalized first coordinates 1161; and the normalized second coordinates 1162 are sorted into a normalized second coordinate histogram 1172 (e.g. H_{yN}), for example by sorting and counting similar and/or same normalized second coordinates 1162.

While the histograms 1171, 1172 may be generated in any suitable format (e.g. including graphical formats and non-graphical formats), an example graphical histogram 1181 is depicted adjacent the normalized first coordinate histogram 1171. However, the histograms 1171, 1172 are generally in a format that may be input into the one or more machine learning algorithms 225. Indeed, the normalized coordinates 1161, 1162 are also generally in a format that may be input into the one or more machine learning algorithms 225.

While the generation of the normalized coordinates 1161, 1162 and the histograms 1171, 1172 are described with respect to the X and Y directions of the given coordinate system 420, the normalized coordinates 1161, 1162 and the histograms 1171, 1172 may be generated for any suitable first direction and second direction of any suitable given coordinate system used across the system 100 when generating trajectories. Indeed, similar to the fixed number of points, a suitable given coordinate system (such as the given coordinate system 420) is used across the system 100 when sampling other trajectories and/or variations of trajectories (including, but not limited to the variations 621), as well as when trajectories are determined from touch gesture input in the system 100 that is to be used by the one or more machine learning algorithms 225 to recognize a two-dimensional touch gesture).

Furthermore, the normalized coordinates 1161, 1162 and the histograms 1171, 1172 may comprise features extracted from a trajectory, at the block 305. In particular, the normalized coordinates 1161, 1162 and the histograms 1171, 1172 may be referred to as coordinate features.

Attention is next directed to FIG. 13 which depicts extraction of other features, and in particular angular features, that may be extracted from a trajectory and variations thereof, and in determining particular normalized sequence of changes in angle between adjacent data points along the trajectory 1121.

In particular, FIG. 13 depicts the trajectory 1121 and the data points 1123 (including the first data point 1124 and the last data point 1125), as well changes in angle between adjacent data points along the trajectory 1121, with each change in angle represented as “On”, where n is an integer representative of an order of a respective change in angle in a sequence of changes in angle.

For example, the dashed line 1201 represents an extension of a line drawn between the first data point 1124 and a second data point 1123. The change in angle θ₁ (e.g. n=1) is the angle between the dashed line 1201 and a line between the second and third data points 1123. Hence, the angle θ₁ represents the change in angle that occurs along the trajectory 1121 between the first and second data points 1123, and the second and third data points 1123. Each subsequent change in the angle θₙ is determine in a similar manner, with dashed lines in the FIG. 12 indicating extensions of lines between previous two adjacent data points, and a change in angle θₙ comprising the angle between a dashed line and a next two adjacent data points. As there are fifteen data points, fourteen changes in angle θ₁, θ₂, θ₃, θ₄, θ₅, θ₆, θ₇, θ₈, θ₉, θ₁₀, θ₁₁, θ₁₂, θ₁₃, θ₁₄, are determined.

Indeed, as depicted, the changes in the angle of the trajectory further may be placed into a sequence 1251, for example according to a position and/or path along the trajectory 1121, similar to as described above with respect to the various sequences of sampling points and data points.

From the sequence 1251, a normalized sequence 1261 of changes in angle between adjacent data points 1123 along the trajectory 1121 are determined, such that the changes in angle in the normalized sequence 1261 are normalized to between −1 and +1, using any suitable normalization process.

From the normalized sequence 1261, a normalized histogram 1271 (e.g. HON) may be determined, for example by sorting and counting similar and/or same normalized angles in the normalized sequence 1261.

Furthermore, the normalized sequence 1261 and the histogram 1271 may comprise features extracted from a trajectory at the block 305 and in particular rotational features.

While determination of the various features that are normalized have been described as occurring in a specific manner, determination of such features, and normalization thereof, may occur in any suitable manner. For example, returning to FIG. 11, non-normalized histograms of the coordinates 1151, 1152 may be determined and the normalized histograms 1171, 1172 determined from the non-normalized histograms. Similarly, returning to FIG. 12, non-normalized histograms of the changes of angle of the sequence 1251 may be determined and the normalized histogram 1271 determined from the non-normalized histogram.

It is further understood that while FIG. 11 and FIG. 12 are described with respect to extracting features from the trajectory 1121, such features are generally associated with the trajectory 421, as the trajectory 1121 is similar to the trajectory 421, but with resampled points 1123.

It is further understood that features may be extracted from each of the variations 621 of the trajectory 421 and/or from the trajectory 581 and variations thereof, in a similar manner as described with respect to FIG. 11 and FIG. 12.

Attention is next directed to FIG. 13 which depicts aspects of the block 307 for generating, from the one or more features extracted at the block 305, one or more machine learning classifiers. While the processor 250 is not depicted, it is understood that the aspects of the block 307 depicted in FIG. 13 are being implemented by the processor 250 and/or the server 108 and/or another suitable computing device (e.g. the client device 104) executing the application 262 and/or a similar application (e.g. the application 224). Furthermore, the aspects of the block 307 depicted in FIG. 13 are understood to be one example of generating, from the one or more features extracted at the block 305, one or more machine learning classifiers and any suitable process for generating, from the one or more features extracted at the block 305, one or more machine learning classifiers is within the scope of the present specification.

In particular, FIG. 13 depicts one or more machine learning classifiers 1325 being generated by training the one or more machine learning algorithms 225 using the features associated with the trajectory 421 and the variations 621. For example, as depicted, the features of the trajectory 421 include: the normalized first coordinates 1161; the normalized second coordinates 1162; the normalized first coordinate histogram 1171; the normalized second coordinate histogram 1172; the normalized sequence 1261 of the changes in the angle; and the normalized histogram 1271 for the normalized sequence 1261 of the changes in the angle.

As depicted, features for the variations 621 are also used to train the one or more machine learning algorithms 225. For example, respective features for the variations 621 may include similar features as the features associated with the trajectory 421 (e.g. normalized first coordinates for a variation 621; normalized second coordinates for a variation 621; a normalized first coordinate histogram for a variation 621; a normalized second coordinate histogram for a variation 621; a normalized sequence of the changes in angle for a variation 621; and a normalized histogram for a normalized sequence of the changes in angle for a variation 621).

However, the features used to train the one or more machine learning algorithms 225 may be any suitable features for the trajectory 421 and the variations 621, with the features for the trajectory 421 and the variations 621 being the same feature types for each of the trajectory 421 and the variations 621.

Furthermore, a respective machine learning classifier 1325 may be generated for each respective feature.

Attention is next directed to FIG. 14 which depicts aspects of the block 309 for storing the one or more machine learning classifiers 1325 at a memory. While the processor 250 is not depicted, it is understood that the aspects of the block 309 depicted in FIG. 14 are being implemented by the processor 250 and/or the server 108 and/or another suitable computing device (e.g. the client device 104) executing the application 262 and/or a similar application (e.g. the application 224). Furthermore, the aspects of the block 309 depicted in FIG. 14 are understood to be one example of storing the one or more machine learning classifiers 1325 at a memory, and any suitable process for storing the one or more machine learning classifiers 1325 at a memory is within the scope of the present specification.

Indeed, FIG. 14 depicts two examples of storing the one or more machine learning classifiers 1325 at a memory.

For example, as depicted, the server 108 and/or the processor 250 implementing the method 300 stores the one or more machine learning classifiers 1325 at the memory 254 in association with a label 1425 identifying a two-dimensional touch gesture associated with the trajectory 421. The label 1425 may be received at the server 108 from the device 104, for example along with the touch gesture data 401. For example, the label 1425 may be received at the input assembly 208 (e.g. as input by an operator of the device 104) in association with receiving the touch gesture data 401. As depicted the label 1425 comprises alphanumeric text indicating the number “6” (and which may alternatively be text “six”, and/or any suitable alphanumeric text, and the like).

As depicted, storing the one or more machine learning classifiers 1325 at a memory may alternatively comprise transmitting the one or more machine learning classifiers 1325 to one or more devices that execute the one or more machine learning algorithms 225 and receives touch gesture input; for example, as depicted, the server 108 is transmitting (e.g. via the network 112) the one or more machine learning classifiers 1325, along with the label 1425, to the device 104 which stores the one or more machine learning classifiers 1325 at the memory 204 in association with a label 1425. In other examples, the label 1425 may not be transmitted, but may be generated at the device 104, as described above.

Alternatively, the one or more machine learning classifiers 1325, along with the label 1425, may be transmitted to the detection device 116 (e.g. by the server 108 and/or the device 104).

Attention is next directed to FIG. 15 which depicts the one or more machine learning algorithms 225 using the one or more machine learning classifiers 1325 to recognize a two-dimensional touch gesture when receiving touch gesture input 1501 that corresponds to the two-dimensional touch gesture. The example of FIG. 15 assumes that the touch gesture input 1501 corresponds to an operator of the device 104 interacting with the touch gesture sensor 220 to draw a number “6” (e.g. the number “6” is the two-dimensional touch gesture). As depicted, the processor 200 is implementing the one or more machine learning algorithms 225 and/or the application 224.

For example, as depicted, the touch gesture input 1501 corresponds to a number “6” similar to the touch gesture data 401; however, the touch gesture input 1501 may have a different number of sampling points than the touch gesture data 401, and furthermore, the touch gesture input 1501 may have a different trajectory and/or shape than the touch gesture data 401.

As depicted, the processor 200 receives the touch gesture input 1501 and determines features 1522 of the touch gesture input 1501, similar to the features determined, as described above with respect to the trajectory 421 and the variations 621. Hence, for example, the processor 200 generates a trajectory from the touch gesture input 1501 using the same given coordinate system 420 (e.g. by redistributing sampling points and offsetting), samples the trajectory at the same fixed number of data points used to determine the features of the trajectory 421 and the variations 621, and determine features of the trajectory (generated from the touch gesture input 1501) that are of the same type as the features of the trajectory 421 and the variations 621. As depicted, the features 1522 may be input into the one or more machine learning algorithms 225 along with the classifiers 1325. The one or more machine learning algorithms 225 determine that one or more of the features 1522 correspond to one or more of the classifiers 1325, and outputs the label 1425. In some examples, the label 1425 may be output with an estimate of a confidence level of a match between the features 1522 and the classifiers 1325. While not depicted, the label 1425 may be used as input to another algorithm (not depicted) which responds to the two-dimensional touch gesture represented by the touch gesture input 1501.

Still further variations to the above systems and methods are contemplated. For example, the one or more machine learning classifiers 1325 discussed above may be deployed for use with other devices, such as the detection device 116. Furthermore, the touch gesture input 1501 may be transmitted to the server 108 which may determine the features 1522, use the one or more machine learning algorithms 225 to determine that one or more of the features 1522 correspond to one or more of the classifiers 1325, and transmit the label 1425 to the device 104.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that in some examples, the functionality of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

The scope of the claims should not be limited by the examples set forth herein, but should be given the broadest interpretation consistent with the description as a whole.

We claim:

1. A method comprising:
generating, at a computing device, a trajectory corresponding to a two-dimensional touch gesture;
generating, at the computing device, a plurality of variations of the trajectory in one or more of two dimensions;
extracting, at the computing device, one or more features of the trajectory and the plurality of variations of the trajectory;
generating, at the computing device, from the one or more features, one or more machine learning classifiers; and
storing, using the computing device, the one or more machine learning classifiers at a memory, such that a machine learning algorithm uses the one or more machine learning classifiers to recognize the two-dimensional touch gesture when receiving touch gesture input.

2. The method of claim 1, further comprising generating the trajectory by:
receiving touch gesture data corresponding to a drawing of the trajectory; and
converting the touch gesture data to the trajectory.

3. The method of claim 2, further comprising converting the touch gesture data to the trajectory by one or more of: removing an off-set from the touch gesture data;
and evenly distributing sampling points in the touch gesture data.

4. The method of claim 1, further comprising generating the trajectory by:
receiving script data defining the trajectory; and converting the script data to the trajectory.

5. The method of claim 1, further comprising generating the plurality of variations of the trajectory by one or more of:
scaling the trajectory in one or more of the two dimensions;
rotating the trajectory;
extending one or more portions of the trajectory;
one or more of cropping and cutting the one or more portions of the trajectory;
distorting the trajectory in one or more of the two dimensions;
elastically distorting the trajectory in one or more of the two dimensions;
applying one or more perspectives to the trajectory in one or more of the two dimensions;
deforming at least a portion of the trajectory; and
distorting at least a portion of the trajectory.

6. The method of claim 1, further comprising extracting the one or more features of the trajectory and the plurality of variations of the trajectory by, for the trajectory and the plurality of variations of the trajectory:
sampling a fixed number of data points representing the trajectory or a variation of the trajectory, the fixed number of data points distributed along the trajectory or the variation of the trajectory, the data points comprising respective coordinates in a given coordinate system; and
determining one or more of:
a normalized sequence of changes in angle between adjacent data points along the trajectory or the variation of the trajectory;
a normalized histogram of the normalized sequence;
a normalized first coordinate histogram of normalized first coordinates, for a first direction in the given coordinate system;
a normalized second coordinate histogram of normalized second coordinates, for a second direction in the given coordinate system,
such that the features comprise, for the trajectory and the plurality of variations of the trajectory, one or more of:
the normalized first coordinates;
the normalized second coordinates;
the normalized first coordinate histogram;
the normalized second coordinate histogram;
the normalized sequence of the changes in the angle; and
the normalized histogram for the normalized sequence.

7. The method of claim 1, wherein the one or more machine learning classifiers are generated by training the one or more machine learning algorithms using the features.

8. The method of claim 1, further comprising storing the one or more machine learning classifiers at the memory in association with a label identifying the two-dimensional touch gesture.

9. The method of claim 1, wherein the storing the one or more machine learning classifiers at the memory comprises transmitting the one or more machine learning classifiers to one or more devices that include the memory, the one or more devices configured to: store the one or more machine classifiers at the memory, execute the machine learning algorithm; and receive the touch gesture input.

10. A computing device comprising:
a controller having access to a memory, the controller configured to:
generate a trajectory corresponding to a two-dimensional touch gesture;
generate a plurality of variations of the trajectory in one or more of two dimensions;
extract one or more features of the trajectory and the plurality of variations of the trajectory;
generate, from the one or more features, one or more machine learning classifiers; and
store, at the memory, the one or more machine learning classifiers, such that a machine learning algorithm uses the one or more machine learning classifiers to recognize the two-dimensional touch gesture when receiving touch gesture input.

11. The computing device of claim 10, wherein the controller is further configured to generate the trajectory by: receiving touch gesture data corresponding to a drawing of the trajectory; and converting the touch gesture data to the trajectory.

12. The computing device of claim 11, wherein the controller is further configured to convert the touch gesture data to the trajectory by one or more of: removing an off-set from the touch gesture data; and evenly distributing sampling points in the touch gesture data.

13. The computing device of claim 10, wherein the controller is further configured to generate the trajectory by: receiving script data defining the trajectory; and
converting the script data to the trajectory.

14. The computing device of claim 10, wherein the controller is further configured to generate the plurality of variations of the trajectory by one or more of:
scaling the trajectory in one or more of the two dimensions;
rotating the trajectory;
extending one or more portions of the trajectory;
one or more of cropping and cutting the one or more portions of the trajectory;
distorting the trajectory in one or more of the two dimensions;
elastically distorting the trajectory in one or more of the two dimensions;
applying one or more perspectives to the trajectory in one or more of the two dimensions;
deforming at least a portion of the trajectory; and
distorting at least a portion of the trajectory.

15. The computing device of claim 10, wherein the controller is further configured to extract the one or more features of the trajectory and the plurality of variations of the trajectory by, for the trajectory and the plurality of variations of the trajectory:
sampling a fixed number of data points representing the trajectory or a variation of the trajectory, the fixed number of data points distributed along the trajectory or the variation of the trajectory, the data points comprising respective coordinates in a given coordinate system; and
determining one or more of:
a normalized sequence of changes in angle between adjacent data points along the trajectory or the variation of the trajectory;
a normalized histogram of the normalized sequence;
a normalized first coordinate histogram of normalized first coordinates, for a first direction in the given coordinate system;
a normalized second coordinate histogram of normalized second coordinates, for a second direction in the given coordinate system,
such that the features comprise, for the trajectory and the plurality of variations of the trajectory, one or more of:
the normalized first coordinates;
the normalized second coordinates;
the normalized first coordinate histogram;
the normalized second coordinate histogram;
the normalized sequence of the changes in the angle; and
the normalized histogram for the normalized sequence.

16. The computing device of claim 10, wherein the controller is further configured to generate the one or more machine learning classifiers by training the one or more machine learning algorithms using the features.

17. The computing device of claim 10, wherein the controller is further configured to store the one or more machine learning classifiers at the memory in association with a label identifying the two-dimensional touch gesture.

18. The computing device of claim 10, further comprising a communication interface, and wherein the controller is further configured to store the one or more machine learning classifiers at the memory by transmitting the one or more machine learning classifiers to one or more devices include the memory, the one or more devices configured to: store the one or more machine classifiers at the memory, execute the machine learning algorithm; and receive the touch gesture input.
